(19) United States
(12) Patent Application Publication
(10) Pub. No.: US 2004/0130764 A1
(43) Pub. Date: Jul. 8, 2004

(54) Angle tunable thin film interference optical filter for wavelength multiplexing

(76) Inventors: Vincent E. Stenger, West Covina, CA (US); Frank Xu, Glendora, CA (US); Xinxiong Zhang, Arcadia, CA (US)

Correspondence Address: CHRISTIE, PARKER & HALE, LLP, P.O. BOX 7068, PASADENA, CA, 91109-7068, US

(21) Appl. No.: 10/655,500

(22) Filed: Sep. 3, 2003

Related U.S. Application Data
(60) Provisional application No. 60/407,280, filed on Sep. 3, 2002.
(60) Provisional application No. 60/407,281, filed on Sep. 3, 2002.
(60) Provisional application No. 60/407,282, filed on Sep. 3, 2002.
(60) Provisional application No. 60/407,283, filed on Sep. 3, 2002.

(51) Int. Cl. G02B 26/08

(52) U.S. Cl. 359/223

(57) ABSTRACT

An angle tunable thin film interference optical filter for wavelength multiplexing and demultiplexing. The optical filter may be used in an OADM to drop one or more target channels from an optical signal without interfering with any channels between a starting channel and the dropped channels. During tuning, all of the channels in the optical signal are expressed. In one embodiment of the optical filter, a filter is fixedly coupled to a tiltable filter stage. Reflections from the filter are collected by a corner mirror for reflection back to the filter. In another embodiment, a plurality of optical elements are coupled to rotationally coupled carousels. In another embodiment, tunable thin film interference optical filters are coupled to rotationally independent carousals for expanded wavelength coverage.

### CROSS-REFERENCE TO RELATED APPLICATIONS

This application claims the benefit of U.S. Provisional Patent Application No. 60/407,281, filed Sep. 3, 2002, U.S. Provisional Patent Application No. 60/407,280, filed Sep. 3, 2002, and U.S. Provisional Patent Application No. 60/407,283, filed Sep. 3, 2002, and U.S. Provisional Patent Application No. 60/407,282, filed Sep. 3, 2002, the contents of which are hereby incorporated by reference as if fully stated herein.

### BACKGROUND OF THE INVENTION

As data traffic such as for internet and digital cable TV services has increased in recent years, more demands have been placed on existing communications networks to make the maximum possible use of available bandwidth. Toward this end, it is advantageous to dynamically maintain the shortest possible route for any data traffic. This usually requires switching of the individual data signals from one network to another. It is thus desirable to be able to rapidly switch and re-route various data signals to maintain optimal paths and assure that bandwidth allocations for customers are met. This is especially true at the metropolitan (access) level, where there are many more access points as compared to long haul (city to city) data traffic. Metro access traffic in particular has been identified as the dominant bandwidth bottleneck in existing telecommunications networks.

In optical networks, data signals are present on optical fibers as modulations of light intensities over discrete optical frequency bands or channels centered at specific light wavelengths. The conventional approach to switching and routing of these optical data signals has been to strip away the optical bands using optical demultiplexers, and then to convert them to electrical signals (o-e conversion). The electrical signals are readily switched to other routes, where they are converted back to optical signals (e-o conversion) and inserted back onto a different path of the optical network using an optical multiplexer. The component used for optical multiplexing and demultiplexing functions is the optical add/drop module (OADM). The o-e and e-o conversions stem from the fact that most existing OADM devices are fixed in optical wavelength and optical bandwidth. A more efficient and higher speed routing can be achieved if the routing could all be done at the optical level, eliminating the need for o-e and e-o conversions. This is based on the inherent noise and bandwidth limitations of the o-e and e-o devices. The key to implementing the all-optical routing is the reconfigurable OADM. This device offers dynamic (tunable) channel optical wavelength and bandwidth selection. With the continued growth in the industry, a premium has been placed on the scalability and interconnectivity of any hardware solution over various network platforms. The realization of such a reconfigurable OADM has thus become especially relevant in the current environment.

Incidence angle tuning of wavelength of thin film filters is a technique used to achieve a wide tuning range (˜30 nm at 1550 nm wavelength) in a single thin film filter component. The angle of incidence of the optical beam to the filter surface is varied to reduce the wavelength below that for normal (perpendicular) incidence. The tuning curve follows a parabolic dependence of wavelength on tuning angle. For example, a filter that exhibits a 6 nm wavelength shift at 8 degrees yields about a 13 nm shift at about 11 degrees.

While angle tuning has been widely adopted as a wavelength tuning technique, there are several drawbacks to the technique when applied to tuning of thin film interference band pass filters. One problem is that as the tuning angle is increased, beam misalignment losses increase and spectral characteristics are degraded. In addition, as the tuning angle is increased, polarization dependant filter losses increase as does dispersion. As the filter is tilted away from normal incidence, there is also loss of the reflected beam spectrum (“express” signal). This is because of the practical issue of how to capture the reflected optical beam as the tuning angle is changed. The reflected beam bounces back at twice the incident angle, further exacerbating the problem. Finally, tuning a filter across a range of channels causes interruption of intermediate channels.

### SUMMARY OF THE INVENTION

An angle tunable thin film interference optical filter for wavelength multiplexing and demultiplexing is provided. The optical filter may be used in an OADM to drop one or more target channels from an optical signal without interfering with any channels between a starting channel and the dropped channels. During tuning, all of the channels in the optical signal are expressed. In one embodiment of the optical filter, a filter is fixedly coupled to a tiltable filter stage. Reflections from the filter are collected by a corner mirror for reflection back to the filter. In another embodiment, a plurality of optical elements are coupled to rotationally coupled carousels. In another embodiment, tunable thin film interference optical filters are coupled to rotationally independent carousals for expanded wavelength coverage.

In one aspect of the invention, an angle tunable thin film interference optical filter, includes a movable filter stage. A thin film interference optical filter and a corner mirror coupled are coupled to the movable filter stage with the corner mirror receiving an optical signal reflected from the thin film interference optical filter. An actuator is coupled to the filter stage and is operable to move the filter stage such that the incidence angle of the optical signal relative to the thin film interference optical filter is modified.

In another aspect of the invention, the tunable filter further includes a beam deflection element optically coupled to the thin film filter.

In another aspect of the invention, a second optical filter optically coupled to the first optical filter is provided along with two optical recirculators for creation of a non-blocking four port optical add/drop module.

In another aspect of the invention, a polarization rotational device is optically coupled between the first and second optical filters.

In another aspect of the invention, a plurality of optical elements are coupled to a first and second carousel. The first and second carousels are rotationally coupled to create a two port tunable filter with expanded wavelength coverage.

In another aspect of the invention, a plurality of filter assemblies are mounted on a first and second carousel for creation of a non-blocking tunable filter with expanded wavelength coverage.

### BRIEF DESCRIPTION OF THE DRAWINGS

These and other features, aspects, and advantages of the present invention will become better understood with regard to the following description, appended claims, and accompanying drawings where:

FIG. 1a to FIG. 1c are graphical representations of the operation of a non-blocking tunable filter in accordance with an exemplary embodiment of the present invention;

FIG. 2 is a diagram of an optical add/drop module in accordance with an exemplary embodiment of the present invention;

FIG. 3a is a block diagram illustrating the operation of a two filter angle tunable thin film filter in accordance with an exemplary embodiment of the present invention;

FIG. 3b is a block diagram illustrating the operation of a two filter angle tunable thin film filter wherein polarization effects are minimized by rotating the filters in accordance with an exemplary embodiment of the present invention;

FIG. 3c is a block diagram illustrating the operation of a two filter angle tunable thin film filter wherein polarization effects are minimized by using a polarization rotation device in accordance with an exemplary embodiment of the present invention;

FIG. 4 is a semi-schematic of an angle tunable thin film filter incorporated into an OADM in accordance with an exemplary embodiment of the present invention;

FIG. 5 is a semi-schematic top view of an alternative corner filter and collimator arrangement for the OADM of FIG. 4 in accordance with an exemplary embodiment of the present invention;

FIG. 6 is a semi-schematic illustration of an angle tunable filter having a beam deflecting element in accordance with an exemplary embodiment of the present invention;

FIG. 7 is a semi-schematic illustration of a two filter angle tunable thin film filter used as an OADM in accordance with an exemplary embodiment of the present invention;

FIG. 8 is a semi-schematic illustration of a non-blocking tunable filter in accordance with an exemplary embodiment of the present invention;

FIG. 9a to FIG. 9d are a sequence of graphs illustrating the operation of a non-blocking tunable filter in accordance with an exemplary embodiment of the present invention;

FIG. 10a to FIG. 10c are graphical representations of the operation of a flexible bandwidth non-blocking tunable filter in accordance with an exemplary embodiment of the present invention;

FIG. 11 is a block diagram of a control system for a non-blocking tunable filter in accordance with an exemplary embodiment of the present invention

FIG. 12 is a process flow diagram of a tuning process for a non-blocking tunable filter in accordance with an exemplary embodiment of the present invention;

FIG. 13 is a two port angle tunable filter having a plurality of filters and beam deflection elements in accordance with an exemplary embodiment of the present invention;

FIG. 14 is a two port tunable filter having a plurality of matched filter elements in accordance with an exemplary embodiment of the present invention; and

FIG. 15 is a three port or four port non-blocking tunable filter having a plurality of dual tunable cascaded filters in accordance with an exemplary embodiment of the present invention.

### DETAILED DESCRIPTION

Incidence angle tuning of thin film optical interference filters is a common technique to achieve broad wavelength tuning ranges in applications such as spectral analysis and general wavelength multiplexing/demultiplexing (WDM) telecom applications. Various exemplary embodiments of the present invention include features for reducing angle tuning effects such as angle (wavelength) dependant polarization sensitivity, insertion loss, and bandwidth effects in an angle tuned thin film interference optical filter. Additional exemplary embodiments include implementations of full 3 and 4 port wavelength multiplexing add/drop and express (reflection) functions with angle-tuned thin film interference optical filters. In one exemplary embodiment of the invention, two filters in cascade are used to implement non-blocking (“hitless”) tuning operation, whereby intermediate wavelengths or channels are not interrupted as the filter is tuned. The tunable two filter embodiment features independent bandwidth control and inherent beam alignment correction for minimal tuning induced optical loss in a reconfigurable Optical Add/Drop (OADM) device.

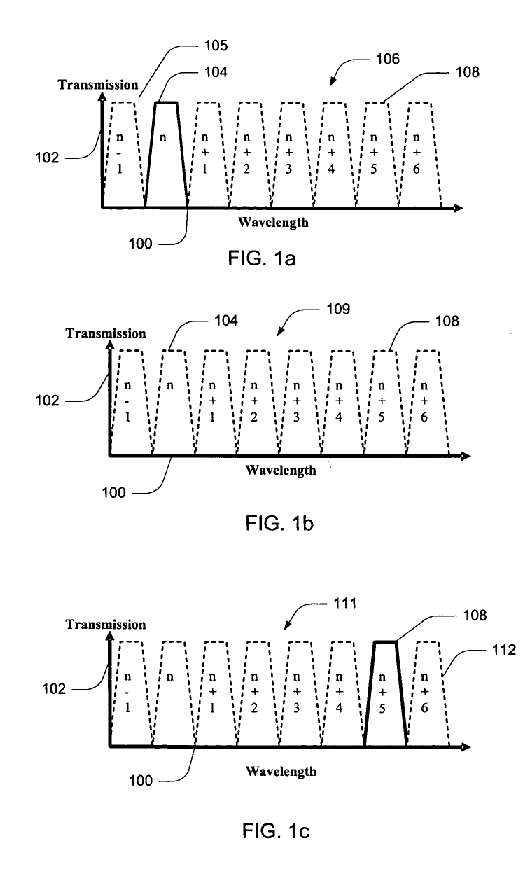

FIG. 1a to FIG. 1c are graphical representations of the operation of a non-blocking tunable filter in accordance with an exemplary embodiment of the present invention. In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted (dropped) channel is illustrated as a channel with a solid outline. A reflected (expressed) channel is illustrated by a dashed outline.

Referring now to FIG. 1a, channel n 104 is shown as being a currently dropped channel with a solid outline. Channel n−1 105 and channels n+1 to n+6 106 are shown as being expressed with a dashed outline. During a tuning process, the non-blocking tunable filter is tuned from the current channel 104 to a target channel, n+5 108, without blocking the intermediate channels.

FIG. 1b is a graph of the state of a non-blocking tunable filter during a transitional or tuning phase. As illustrated, channels n−1 to n+6 109 are shown as being expressed using a dashed outline. During the transitional phase, all channels are expressed as the non-blocking tunable filter tunes from a current channel 104 to the target channel 108.

FIG. 1c is a graph of the state of a non-blocking tunable filter after it has tuned to a target dropped channel. In the graph, channels n−1 to n+4 111 and channel n+6 112 are shown with dashed outlines indicating that they are expressed by the non-blocking tunable filter. Channel n+5 108 is shown with a solid outline indicating that it is being dropped or transmitted by the non-blocking tunable filter.

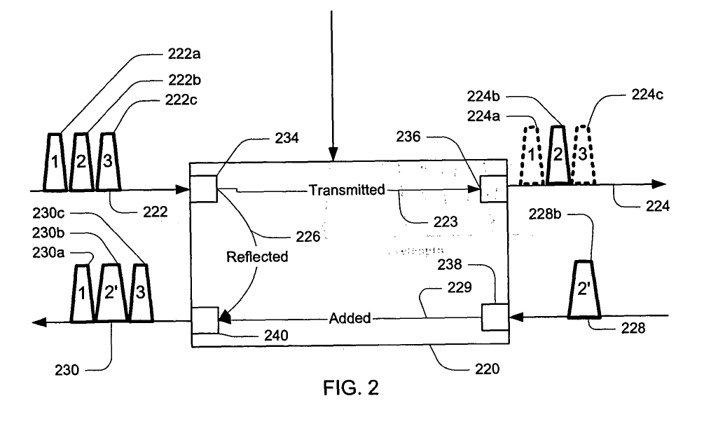

FIG. 2 is a block diagram of the operation of a tunable Optical Add/Drop Module (OADM) in accordance with an exemplary embodiment of the present invention. An OADM 220 receives an input optical signal 222 at an input port 234. The input optical signal may have multiple channels with each channel occupying specific optical bandwidths at various channel wavelengths, such as channel 1 222a, channel 2 222b, and channel 3 222c. In the optical signals, some of the channels may be present and are indicated using a solid outline. Some of the channels may be absent and these are indicated by a dashed outline.

Within the tunable filter, a dropped channel is transmitted (223) through the device and out of a drop port 236 as a component of a dropped optical signal 224. As illustrated, the dropped optical signal includes dropped channel 2 224b as indicated by channel 2's solid outline. Channels 1 224a and 3 224c are not present in the dropped optical signal as indicted by their dashed outlines.

The input channels that are not transmitted as part of the dropped optical signal are reflected (226) by the device as components of an expressed optical signal 230 out of an express port 240. Channels may also be added (229) to the expressed optical signal by the filter. For example, an add optical signal 228 at an add port 238 may contain an optical signal on channel 2′ 228b corresponding to the dropped channel 2 224b. The resultant expressed optical signal 230 then includes channel 1 230a, channel 2′ 230b, and channel 3 230c. An input optical signal on channel 2 222b is dropped as channel 2 224b. The dropped channel was replaced in the expressed optical signal by channel 2′ 230b.

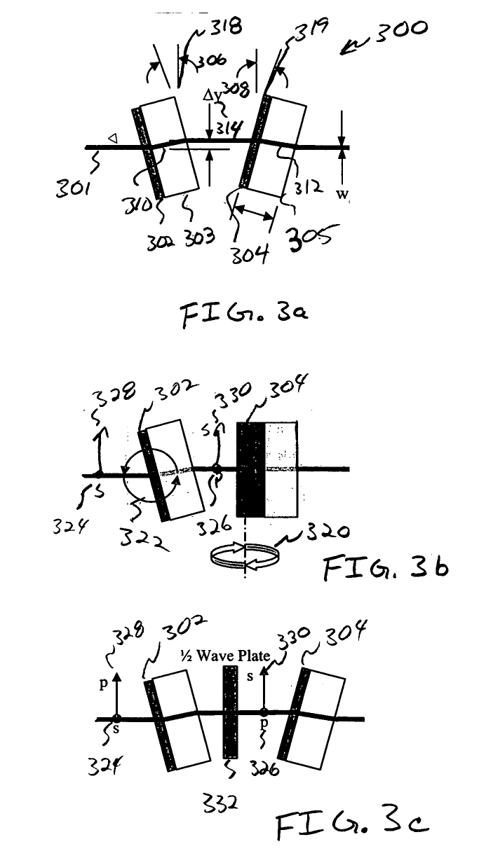

FIG. 3a is a block diagram illustrating the operation of a two filter angle tunable thin film filter in accordance with an exemplary embodiment of the present invention. In a two filter angle tunable thin film filter 300, a first optical filter 302 and a second optical filter 304 in the optical path 301 of an optical signal are tuned to approximately equal but opposite θ angles, angle 306 and angle 308 respectively, to achieve transmission spectrum overlap. A relative offset angle, Δθ, between the filters and optical path, 318 for the first filter and 319 for the second filter, is introduced to control the amount of spectral overlap, and thus control the transmission bandwidth over the whole angle tuning range. This allows the two filter angle tunable thin film filter to achieve equal and arbitrary bandwidth for fully reconfigurable OADM functions. The effects of refraction (310) in the first optical filter on the beam alignment are compensated by the equal and opposite refraction (312) angle in the second filter. This minimizes the tilt angle (wavelength) dependent optical loss.

To determine the amount of loss compensation from the second filter, the angle induced beam offset from the first filter can be shown by Snell's law to be:

Δy=t·sin(θ−θ/nₛ)

where t is the filter/substrate thickness, θ is the optical beam incident angle to the filter surface (0 is normal incidence), and nₛ is the substrate optical refractive index. For example, at 12 degrees, the vertical offset of the beam for a 2 mm thick filter/substrate at a refractive index of 1.5 would be about 0.14 mm. The beam offset, Δy 314, dependent loss can be approximated by:

L(Δy)˜4.343 [Δy/wₒ]² (dB)

where wₒ is one half the beam 1/e² width. For a 2wₒ=1 mm beam at 12 degrees, the loss would be about 0.34 dB for a single filter solution.

FIG. 3b is a block diagram illustrating the operation of a two filter angle tunable thin film filter wherein polarization effects are minimized by rotating the filters in accordance with an exemplary embodiment of the present invention. To reduce polarization effects, an axis of rotation 320 of the second filter 304 may be made perpendicular (rotated 90 degrees) to the axis of rotation 322 of the first filter 302 such that incident s and p polarizations are switched between the first filter and the second filter. This causes incident polarization to be effectively scrambled in transmission, since both s and p incident polarizations will each effectively experience both s and p polarization effects. The s 324 incident component of the first filter, shown coming out of the plane of the page, will become a p component 326, shown coming out of the plane of the page, for the second filter. The p incident component 328 of first filter will likewise be the s component 330 of the second filter. To implement this polarization rotation, the axis of rotation between the two filters may physically be rotated. One advantage of physical rotation is that the polarization independent response will not be wavelength dependant. However, the physical rotation approach incurs angle dependant loss because of beam misalignment in both rotational directions. This may be reduced by inserting beam deflecting optics, and/or by using a larger beam size to minimize beam translation induced optical loss.

FIG. 3c is a block diagram illustrating the operation of a two filter angle tunable thin film filter wherein polarization effects are minimized by using a polarization rotation device in accordance with an exemplary embodiment of the present invention. To reduce polarization effects, a polarization rotation device 332 may be inserted between the filters. Exemplary polarization rotation devices include a half-wave plate at a 45 degree rotation to the s, 324 and 330, and p, 328 and 326, incident polarizations, or a Faraday rotator used to achieve 90 degree polarization rotation for s and p averaging.

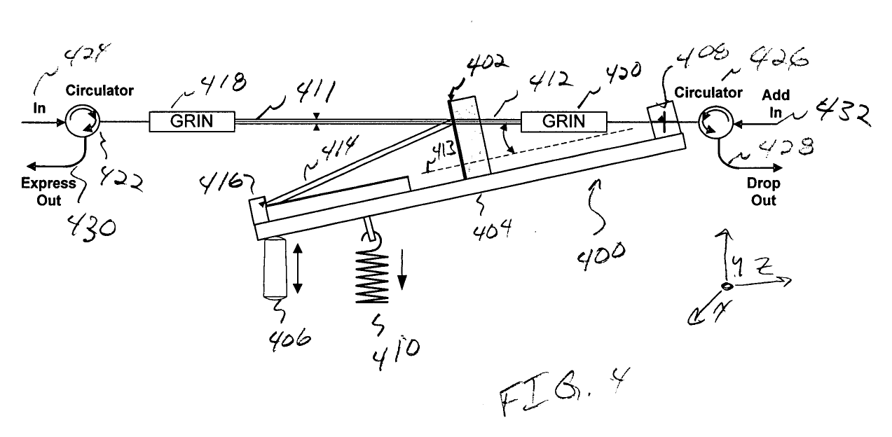

FIG. 4 is a semi-schematic of an angle tunable thin film filter incorporated into a tunable OADM in accordance with an exemplary embodiment of the present invention. An OADM 400 may be created using a thin film optical filter 402 fixedly attached to a movable filter stage 404. The moveable filter stage is translated by an actuator 406 around a pivot point 408. A restoring device 410 provides a restoring force in opposition to the actuator's force.

The filter is placed into an optical path 411 such that pivoting the filter stage causes the incident angle 413 between the optical path and the filter to be changed. An input optical signal traveling along the optical path impinges on the filter. In response to the impinging input optical signal, the filter transmits a portion of the input optical signal as a dropped optical signal 412 including one or more dropped channels. The specific dropped channels are determined by the incident angle between the input optical signal and the filter. Another portion of the input optical signal path is reflected by the filter as an expressed optical signal 414 including one or more expressed channels. The expressed optical signal strikes a corner mirror 416 and is reflected back into the optical filter. As the reflected expressed optical signal is reflected back along the same optical path as the expressed optical signal, the incident angle of the reflected expressed optical signal is identical in magnitude to, but opposite in sign, to the impinging input optical signal. As such the reflected expressed optical signal is transmitted back along the same optical path as the input optical signal.

A first GRadient INdex (GRIN) collimator is used to both transmit the input optical signal along the optical path to the filter and to collect the reflected expressed optical signal. A first optical circulator 422 optically coupled to the first collimator receives the reflected expressed optical signal and routes it to an express port 340 for transmission out of the OADM as an expressed optical signal. The first circulator also accepts the input optical signal at an input port 424 and transmits the input optical signal to the first collimator for transmission to the filter.

A second GRIN collimator 420 collects the dropped optical signal and transmits the dropped optical signal to a second optical circulator 426. The second optical circulator routes the dropped optical signal to a drop port 428 for transmission out of the OADM. The second circulator may also receive an add optical signal including an add channel corresponding to the drop channel from an add port 432. The second circulator routes the add optical signal to the second collimator which injects the add optical signal into the filter. The filter transmits the add optical signal to the first collimator. The first collimator collects the add optical signal and transmits the add optical signal to the first circulator. The first circulator routes the add optical signal to the express port, thus adding the add optical signal to the reflected express optical signal transmitted out of the OADM.

In an alternative OADM in accordance with an exemplary embodiment of the present invention, the second optical circulator is not used. In this embodiment, the OADM is a three port device as the OADM does not have an add port.

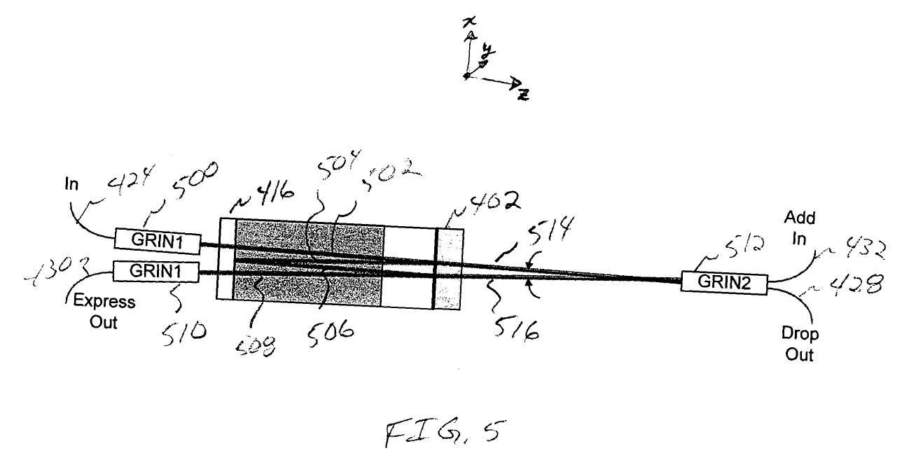

FIG. 5 is a semi-schematic top view of an alternative corner filter and collimator arrangement for the OADM of FIG. 4 in accordance with an exemplary embodiment of the present invention. In this embodiment, an input collimator 500 directs an input optical signal along an input optical path 502 having a non-zero lateral incidence angle in the X-Z plane between the optical path and the filter 402. An expressed optical signal 504 reflected by the filter is transmitted to the corner mirror 416. As the input optical signal has a non-zero lateral incidence angle with respect to the filter, so does the expressed optical signal have a non-zero lateral incidence angle with respect to the corner mirror. The resultant reflected expressed optical signal 506 also has a non-zero incidence angle with respect to the filter. The reflected expressed optical signal is reflected again by the filter and into an express port collimator 510. The express port collimator collects the twice reflected expressed optical signal and transmits the twice reflected expressed optical signal out of an express port 430.

A dual collimator 512 is used to collect a drop optical signal 514 transmitted through the filter and route the dropped optical signal to a drop port. The dual collimator may also receive an add optical signal from an add port 432 and route the add optical signal to the 516 through the filter and into the express collimator 510 for addition to the expressed optical signal.

In another embodiment, the dual collimator may be replaced by two single collimators as used at the input port and express port of the OADM to implement separate add and drop ports.

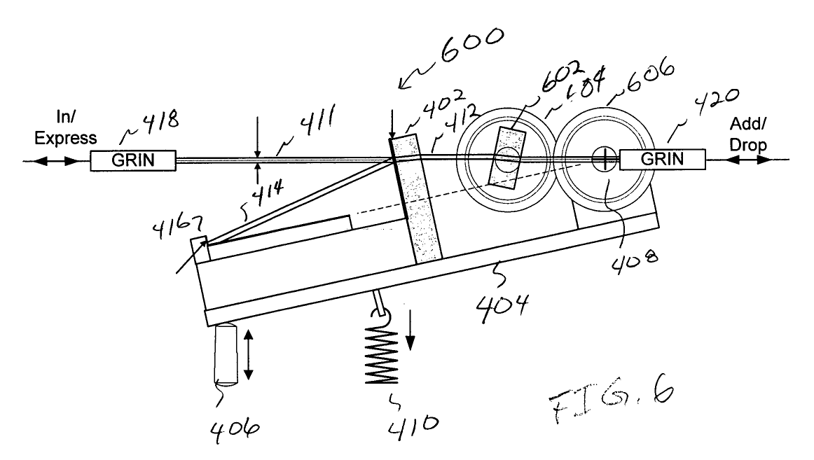

FIG. 6 is a semi-schematic illustration of an angle tunable filter having a beam deflecting element in accordance with an exemplary embodiment of the present invention. As previously described, an OADM 600 may be created using a thin film optical filter 402 fixedly attached to a movable filter stage 404. The moveable filter stage is translated by an actuator 406 around a pivot point 408. A restoring device 410 provides a restoring force in opposition to the actuator's force.

The filter is placed into an optical path 411 such that an input optical signal traveling along the optical path impinges on the filter. In response to the impinging input optical signal, the filter transmits a portion of the input optical signal as a dropped optical signal 412 including one or more dropped channels. Another portion of the input optical signal is reflected by the filter as an expressed optical signal 414 including one or more expressed channels. The expressed optical signal strikes a corner mirror 416 and is reflected back into the optical filter. As the reflected expressed optical signal is reflected back along the same optical path as the expressed optical signal, the incident angle of the reflected expressed optical signal is identical in magnitude to, but opposite in sign, to the impinging input optical signal. As such the reflected expressed optical signal is transmitted back along the same optical path as the input optical signal.

A first GRadient INdex (GRIN) collimator 418 is used to both transmit the input optical signal along the optical path to the filter and to collect the reflected expressed optical signal. A second GRIN collimator 420 collects the dropped optical signal. The optical circulators 422 and 432 (both of FIG. 4) are not shown in the interest of clarity.

A beam deflecting element 602, such as a blank substrate not having a thin film optical filter, except perhaps an antireflective coating, is fixedly coupled to a first movable mount 604 and inserted into the dropped optical signal's optical path. The movable mount may be rotated so as to adjust the incidence angle between the beam deflecting element and the dropped optical signal. The movable mount is rotationally coupled, such as by a gear 606, to the filter stage of the filter element at a coupling ratio that makes the tilt angles of the filter and beam deflecting element equal as the filter stage is angle tuned by pivoting the filter stage about pivot point 408. Either of the three or four port embodiments of the OADM of FIG. 4 may include a beam deflection element.

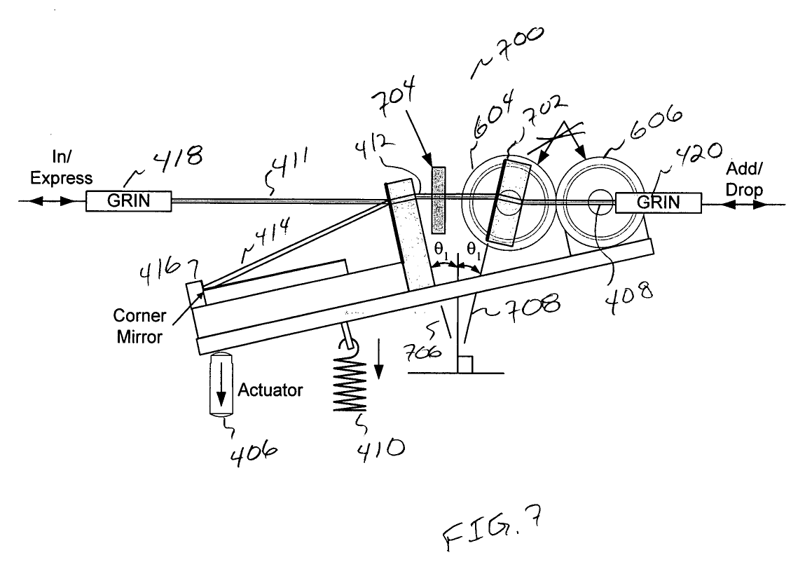

FIG. 7 is a semi-schematic illustration of a two filter angle tunable thin film filter used as an OADM in accordance with an exemplary embodiment of the present invention. As previously described, an OADM 700 may be created using a first thin film optical filter 402 fixedly attached to a first movable filter stage 404. The first filter stage is translated by an actuator 406 around a pivot point 408. A restoring device 410 provides a restoring force in opposition to the actuator's force.

The first filter is placed into an optical path 411 such that an input optical signal traveling along the optical path impinges on the filter. In response to the impinging input optical signal, the first filter transmits a portion of the input optical signal as a dropped optical signal 412 including one or more dropped channels. Another portion of the input optical signal is reflected by the first filter as an expressed optical signal 414 including one or more expressed channels. The expressed optical signal strikes a corner mirror 416 and is reflected back into the first optical filter. As the reflected expressed optical signal is reflected back along the same optical path as the expressed optical signal, the incident angle of the reflected expressed optical signal is identical in magnitude to, but opposite in sign, to the impinging input optical signal. As such the reflected expressed optical signal is transmitted back along the same optical path as the input optical signal.

A first GRadient INdex (GRIN) collimator 418 is used to both transmit the input optical signal along the optical path to the filter and to collect the reflected expressed optical signal. A second GRIN collimator 420 collects the dropped optical signal. The optical circulators 422 and 432 (both of FIG. 4) are not shown in the interest of clarity.

In a two filter OADM, a second thin film optical filter 702 attached to a substrate 703, acting as a beam deflecting element, is fixedly coupled to a second filter stage 604 and inserted into the dropped optical signal's optical path. The second filter stage may be rotated so as to adjust the incidence angle between the second filter and the dropped optical signal. The second filter stage is rotationally coupled, such as by a gear 606, to the first filter stage of the first filter element at a coupling ratio that makes a tilt angle 706 of the first filter and a tilt angle 708 of the second filter equal in magnitude but opposite in sign relative to the optical path as the filter stage is angle tuned by pivoting the filter stage about pivot point 408.

In one embodiment of a two filter OADM in accordance with an exemplary embodiment of the present invention, a polarization rotation device 704 may be introduced into the optical path between the first and second filter to reduce polarization effects as illustrated in FIG. 3c. In another embodiment of a two filter OADM in accordance with an exemplary embodiment of the present invention, the first filter is rotably mounted to the first filter stage and the second filter is rotably mounted to the second filter stage such that the polarization effects may be reduced as illustrated in FIG. 3b.

In another embodiment, the coupling ratio between the first filter stage and the second filter stage has a non unity value. This allows the introduction of a relative offset angle, Δθ, between the filters and optical path, 318 for the first filter and 319 for the second filer (both of FIG. 1a), to vary the amount of spectral overlap, over tuning angle and thus equalize the transmission bandwidth over the whole angle tuning range.

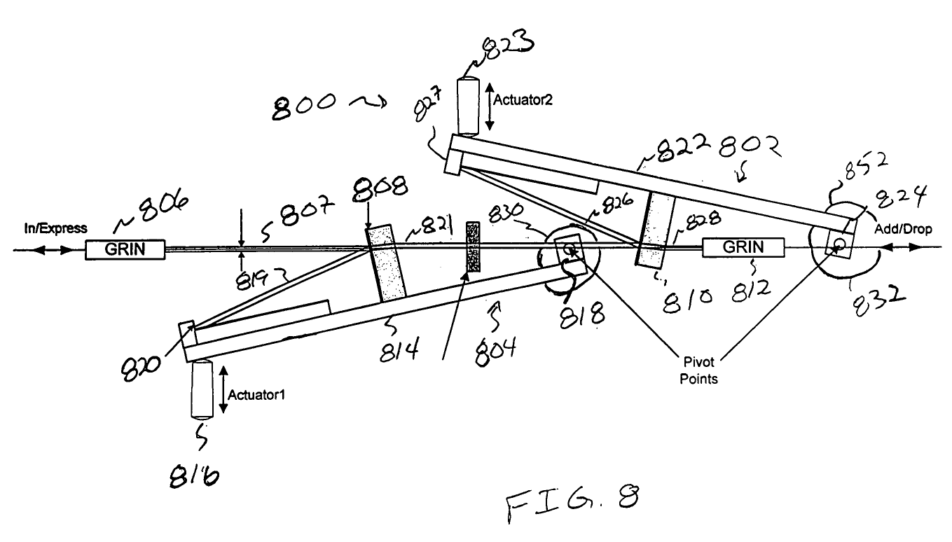

FIG. 8 is a semi-schematic illustration of a non-blocking tunable filter in accordance with an exemplary embodiment of the present invention. A non-blocking tunable filter 800 includes a first tunable filter 802 and a second tunable filter 804 optically coupled together. A first collimator 806 introduces an optical signal 807 that is transmitted through a first optical filter element 808, a second optical filter element 812, and finally to a second collimator 812.

The first filter element is mechanically coupled to a first filter stage 814 such that an actuator is operational to rotate the first filter stage about a first pivot point. In doing so, the incident angle of the optical signal entering the first filter is increased such that a first expressed optical signal 819 is generated as previously illustrated in FIG. 4. The first expressed optical signal is reflected by a first corner filter 820 back to the first filter. The first filter reflects the reflected first expressed optical signal back to the first collimator as previously described. A first dropped optical signal 821 includes any channels that the first filter has dropped as previously described.

The second filter is attached to a second filter stage 822. A second actuator 823 is operable to pivot the second filter stage about a second pivot point 824 so as to change the incident angle between the second filter stage and the first dropped optical signal. A portion of the first dropped optical signal is reflected from the second filter as a second expressed optical signal 826 into a second corner mirror 827. The second corner mirror reflects the second expressed optical signal back to the second filter. The second filter reflects the reflected second optical signal back to the first filter. The second expressed optical signal is thus added to the first optical signal when the second expressed optical signal is transmitted through the first filter and to the first collimator.

A portion of the first dropped optical signal is transmitted through the second filter as a second dropped optical signal 828 and is collected by the second collimator.

A polarization rotation device 808 may be inserted into the optical path to minimize polarization effects between the two tilted filters as previously described.

If the first and second filter are tuned to drop the same channels, an input optical signal is processed in the following manner. The first filter receives the input optical signal having one or more channels selected to be dropped. The first filter transmits the selected drop channels to the second filter. The second filter receives the selected drop channels and transmits the selected drop channels through to the second channel's dropped port as components of a dropped optical signal having the selected dropped channels. As the intermediate dropped optical signal includes only the selected dropped channels, the second filter does not express any channels other than added channels. The first filter expresses all of the channels not selected as drop channels and all of the channels added by the second filter that overlap the transmission of the first filter.

If the first and second filter are tuned to drop different channels, an optical signal received by the first optical filter is processed in the following manner. The first filter receives the optical signal and transmits an intermediate dropped channel optical signal including any dropped channels to the second filter. However, as the second filter is commanded to drop different channels, the second filter reflects the channels dropped by the first filter back to the first filter as an intermediate expressed optical signal including the channels originally dropped by the first filter. No channels reach the second filter's dropped port. Thus, none can make it back to the first filter express port either. Any added channels received by the second filter are also transmitted to the first filter as part of the intermediate expressed optical signal. The first filter receives the intermediate expressed optical signal, including the intermediate dropped channels transmitted by the first filter to the second filter, as an add signal. The first filter's expressed optical signal then includes all of the channels reflected by the first filter, and any channels originally dropped by the first filter but expressed by the second filter.

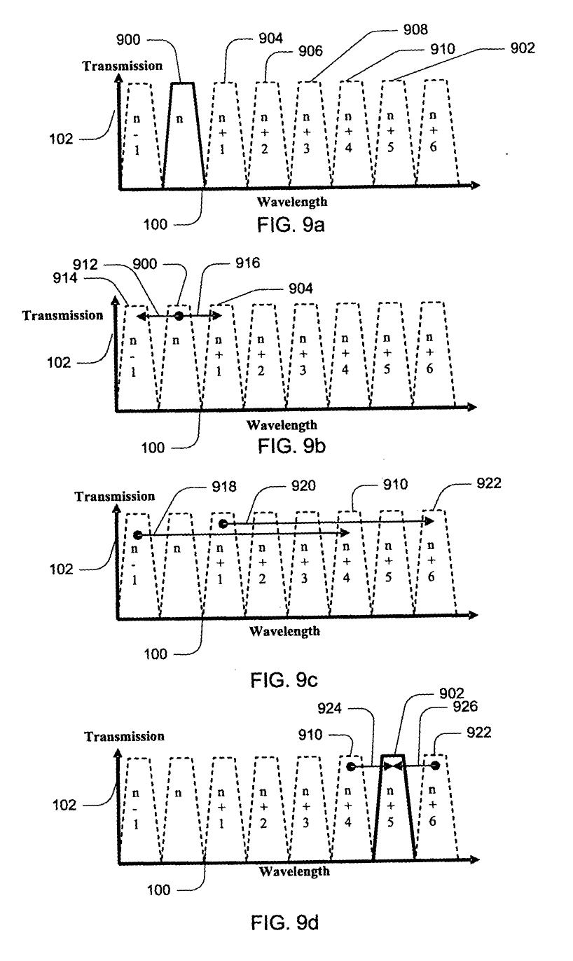

FIG. 9a to FIG. 9d are a sequence of graphs illustrating the operation of a non-blocking tunable filter in accordance with an exemplary embodiment of the present invention. In the graphs, the possible outputs of a non-blocking tunable optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 9a, initially, the first filter 808 and the second filter 810 (both of FIG. 8) are tuned to a starting channel, channel n 900, thus allowing transmission of the starting channel. To tune to a target channel, in this example channel n+5 902, each filter needs to pass through expressed channels n+1 904, n+2 906, n+3 908, and n+4 910.

Referring now to FIG. 9b, the first filter 808 (of FIG. 8) is simultaneously detuned (912) from the starting channel n 900 to a channel adjacent to the starting channel, channel n−1 914. The second filter 810 (of FIG. 8) is detuned (916) to another channel adjacent to the starting channel but in an opposite direction as the first filter from the current channel, in this case channel n+1 904. As noted above, as the first and second filters are tuned to different channels, all of the channels are reflected as express channels as indicated by the dashed outlines of the illustrated channels.

Referring now to FIG. 9c, the second filter 810 (of FIG. 8) is tuned to a channel adjacent to the target channel, in this example to channel n+6 922. The first filter 808 (of FIG. 8) is tuned (918) to another channel adjacent to the target channel but in an opposite direction as the second filter, in this example to channel n+4 910. Thus, at no time do the two filters transmit the same channel during the tuning step.

Referring now to FIG. 9d, the first filter 808 (of FIG. 8) is tuned (924) to the target channel 902 from the first filter's adjacent channel 910. The second filter 810 (of FIG. 8) is simultaneously tuned (926) from the second filter's adjacent channel 922 to the target channel 902. As both filters are now tuned to the target channel, the target channel is dropped by both filters as indicated by the target channel's solid outline.

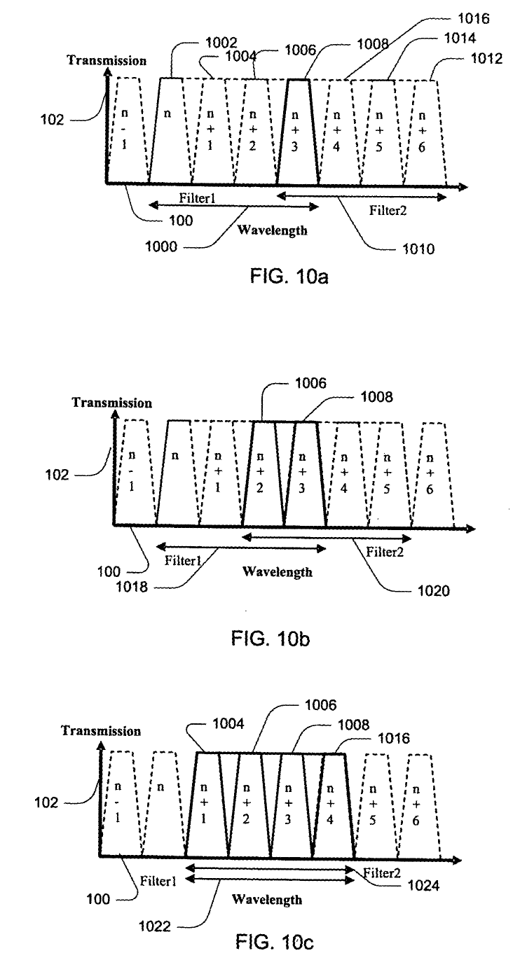

FIG. 10a to FIG. 10c are graphical representations of the operation of a flexible bandwidth non-blocking tunable filter in accordance with an exemplary embodiment of the present invention. Tunable filters may include thin film filter elements that may be used to drop blocks of adjacent channels from a WDM optical signal. Two such filters, optically coupled in a series cascade as previously described, may be advantageously employed to provide flexible control to drop one or more channels simultaneously. In the graphs, the possible outputs of a non-blocking tuned optical filter are illustrated along a graph of transmission versus wavelength for specific channels having defined wavelength bands. The channels processed by the filter are illustrated on a graph having each channel plotted along an X axis 100 and relative transmission of the wavelengths in the channel along a Y axis 102. A transmitted or dropped channel is illustrated as a channel with a solid outline. A reflected or expressed channel is illustrated by a dashed outline.

Referring now to FIG. 10a, a first filter 808 (of FIG. 8) is tuned to drop a first set 1000 of channels, namely channel n 1002, channel n+1 1004, channel n+2 1006, and channel n+3 1008. A second filter 810 (of FIG. 8) is tuned to drop a second set 1010 of channels, namely channel n+6 1012, channel n+5 1014, channel n+4 1016, and channel n+3 1008. As the first and second filter have one common dropped channel, channel n+3, the common dropped channel is included in a dropped optical signal generated by the second filter as indicated by channel n+3's solid outline. All of the rest of the channels, including those channels dropped by either the first filter or the second filter but not by both filters, are expressed as indicated by the channel's dashed outlines.

Referring now to FIG. 10b, the first filter 806 (of FIG. 8) is tuned to drop a first set of channels 1018. The second filter 1014 (of FIG. 8) is tuned to drop a second set of channels 1020. In this configuration, the overlap or intersection between the first and second set of dropped channels includes channel n+2 1006 and channel n+3 1008. As such, both channels are dropped by both filters and included in a dropped channel optical signal transmitted from the second filter as indicated by the included channel's solid outlines. All the rest of the channels are expressed as indicated by their dashed outlines. In the case where there is no overlap between the first and second set of dropped channels, that is the intersection between the two sets is empty, all of the channels will be expressed.

Referring now to FIG. 10c, a first set of dropped channels 1022 dropped by the first filter 808 (of FIG. 8) is identical to a second set of channels 1024 dropped by the second filter 810 (of FIG. 8). As such, channel n+1 1004, channel n+2 1006, channel n+3 1008, and channel n+4 1016 are included in a dropped channel optical signal transmitted from the second filter as indicated by the included channel's solid outlines. All the rest of the channels are expressed as indicated by their dashed outlines.

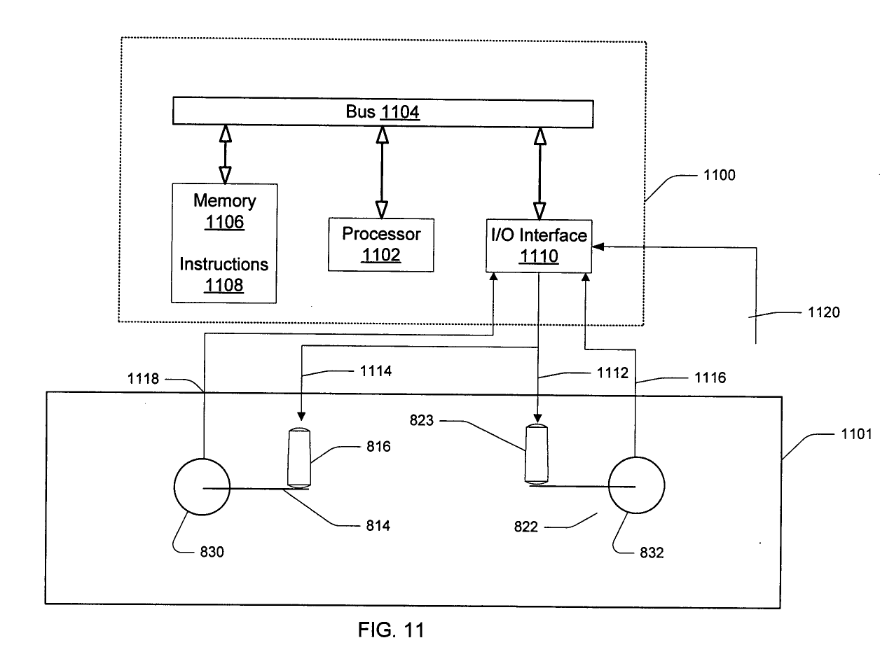

FIG. 11 is a block diagram of a control system for a non-blocking tunable filter in accordance with an exemplary embodiment of the present invention. A controller 1100 is operably coupled to a tunable filter 1101 at a first actuator 816 and a second actuator 823, both of which are described in FIG. 8. The first actuator is operable to pivot a first filter stage 814 around a first pivot point 818. A first position sensor 830 senses the position of the first filter stage and generates a first filter stage position signal that is transmitted to the controller.

The controller is further coupled to the second actuator. The second actuator is operable to pivot a second filter stage 822 around a second pivot point 824. A second position sensor 832 senses the position of the second filter stage and generates a second filter stage position signal that is transmitted to the controller.

The controller includes a processor 1102 coupled to a bus 1104. The bus is coupled to a memory 1106 having program instructions 1008 stored therein. The processor uses the program instructions to implement the features of a tunable filter as described herein. The process is further coupled via the bus to an I/O interface 1110. The processor uses the I/O device to receive signals from and send signals to the tunable filter.

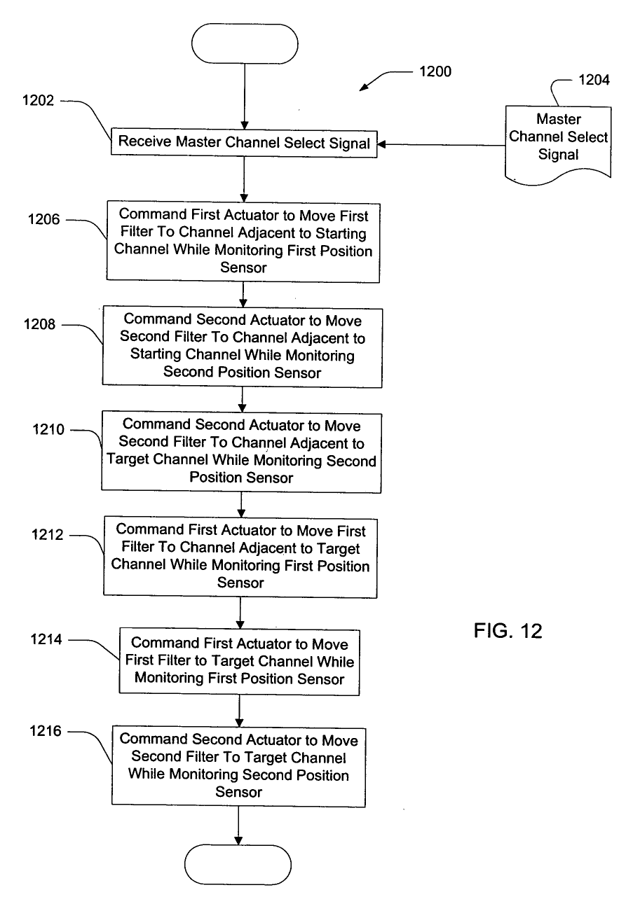

FIG. 12 is a process flow diagram of a tuning process for a non-blocking tunable filter in accordance with an exemplary embodiment of the present invention. A controller 1100 (of FIG. 11) uses a tuning process 1100 to tune a non-blocking tunable filter 800 (of FIG. 8). The controller receives (1102) a master channel select signal 1204 indicating which channels should be dropped. In response to the master channel select signal, the controller commands (1206) a first actuator 816 (of FIG. 8) to position the first filter 808 (of FIG. 8) to drop a channel adjacent to the starting channel. The controller determines the position of the first filter by monitoring first filter translation signals 1118 (of FIG. 11) generated by a first position sensor 830 (of FIG. 8). The controller simultaneously commands (1108) a second actuator 823 (of FIG. 8) to position the second filter 810 (of FIG. 8) to drop a second channel adjacent to the starting channel wherein the second adjacent channel and the first adjacent channel are not the same. The controller determines the position of the second filter by monitoring second filter translation signals 1116 (of FIG. 11) generated by a second position sensor 824 (of FIG. 8) in response to movement of the second filter.

Once both filters are in position adjacent to the starting channel, the controller commands (1110) the second actuator to position the second filter to drop a third channel adjacent to a selected target channel. The controller determines the position of the second filter by monitoring second filter translation signals generated by the second encoder. The controller also commands (1112) the first actuator to position the first filter to drop a fourth channel adjacent to the target channel wherein the fourth adjacent channel and the third adjacent channel are not the same. The controller determines the position of the first filter by monitoring first filter translation signals generated by the first encoder in response to movement of the first filter. The two filter channels never overlap during this tuning step.

Once both filters are in position to drop channels adjacent to the target channel, the controller commands (1114) the first and second actuators to simultaneously position the first and second filters to drop the selected target channel. The controller determines the position of the first filter by monitoring first filter translation signals generated by the first encoder. The controller determines the position of the second filter by monitoring second filter translation signals generated by the second encoder in response to movement of the second filter. After the end of the process, the tunable wavelength filter has positioned the filters to drop the target channels and express any other channels from the input optical signal.

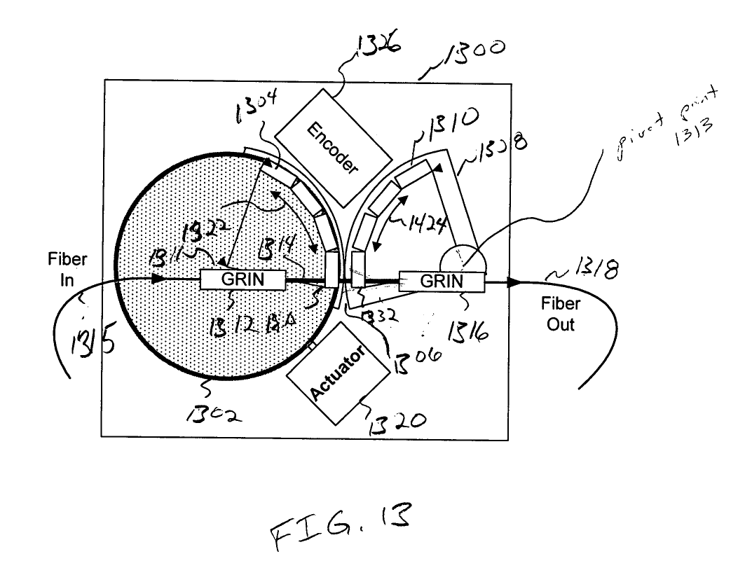

FIG. 13 is a two port angle tunable filter having a plurality of filters and beam deflection elements in accordance with an exemplary embodiment of the present invention. A two port angle tunable filter having a plurality of filters 1300 includes a plurality of filter elements 1304 mounted on a peripheral portion of a first carousel 1302. A corresponding number of beam deflection elements 1310 are mounted on the on a peripheral portion of a second carousel 1308. The first carousel and the second carousel are rotationally coupled, such as by gearing 1306, such that as the first carousel is rotated 1322 about a first pivot point 1311, the second carousel rotates 1324 an equal but opposite amount around a second pivot point 1313.

A first collimator 1312 receives an input optical signal 1315 and transmits the input optical signal along an optical path 1314 to a second collimator 1316. A filter element 1330 from the plurality of filter elements and a beam deflection element 1332 are inserted into the optical path by the first and second carousel respectively. As the filter element and the beam deflection element are located on the periphery of their respective carousels, the relative angle between the elements, and the relative angle of each element with respect to the optical path, may be adjusted by rotation of the carousels. This creates a two optical element tunable filter similar in operation to the angle tunable filters illustrated in FIG. 1a and FIG. 6.

The carousel may be coupled to an actuator 1320 operable to rotate the first carousel and thus the second carousel as well. A position sensor 1326 may be coupled to the first or second carousel to sense the position of the carousels.

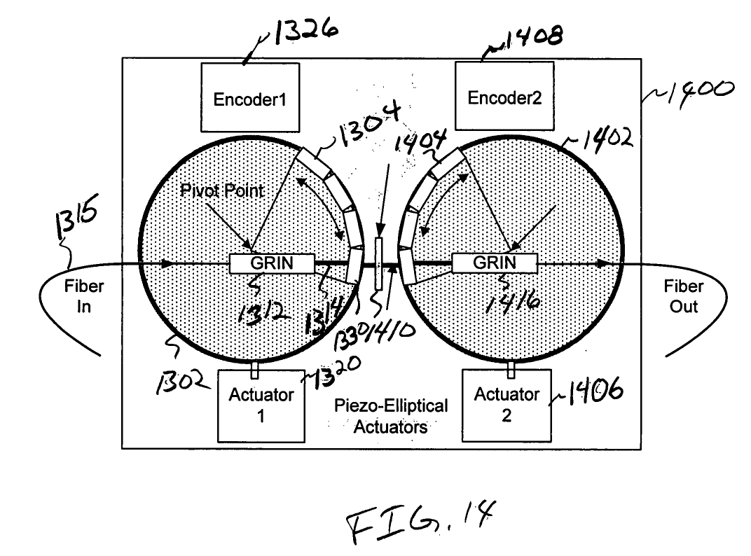

FIG. 14 is a two port tunable filter having a plurality of matched filter elements in accordance with an exemplary embodiment of the present invention. A two port tunable filter having a plurality of matched filter elements 1400 operates in a manner similar to the dual filter element filter elements described in FIG. 3a, FIG. 3b, FIG. 3c, and FIG. 7. A first set of filter elements 1304 are mounted on a peripheral portion of a first carousel 1302. A corresponding second set of filter elements 1404 are mounted on the peripheral portion of a second carousel 1402. In contrast to the tunable filter of FIG. 13, the first carousel and the second carousel are not coupled. Instead, the first carousel and the second carousel are rotated by a first actuator 1320 and a second actuator 1406 respectively. The position of the first carousel is sensed by a first position sensor 1326 and the position of the second carousel is sensed by a second position sensor 1408.

A first collimator 1312 receives an input optical signal 1315 and transmits the input optical signal along an optical path 1314 to a second collimator 1316. A first filter 1330 from the first set filter elements and a second filter from the second set of filter elements 1332 are inserted into the optical path by the first and second carousel respectively. As the first filter and the second filter are located on the periphery of their respective carousels, the relative angle between the filters, and the relative angle of each filter with respect to the optical path, may be adjusted by rotation of the carousels. A polarization element 1410 is inserted into the optical path between the two filter elements to minimize the polarization effects as previously described. This creates a two filter tunable filter similar in operation to the tunable angle filters illustrated in FIG. 3a, FIG. 3b. FIG. 3c, and FIG. 7.

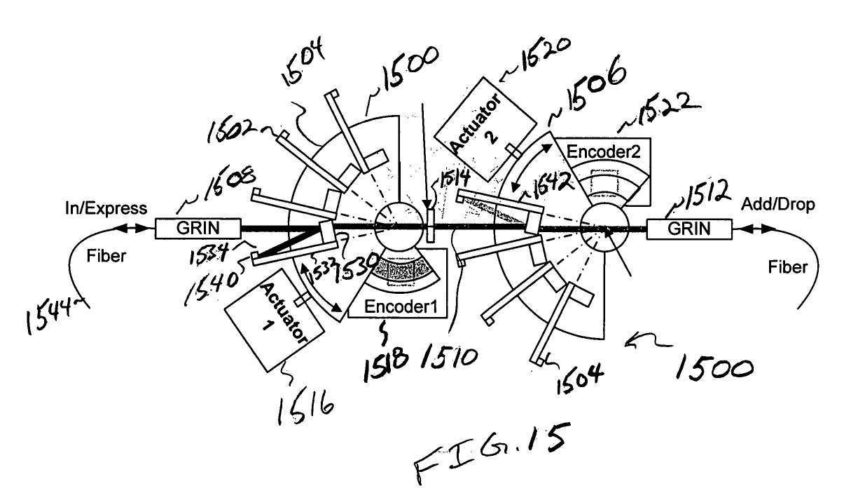

FIG. 15 is a three port or four port non-blocking tunable filter having a plurality of dual tunable cascaded filters in accordance with an exemplary embodiment of the present invention. The operation of a non-blocking tunable filter having a plurality of dual tunable cascaded filters 1500 is similar to the non-blocking filter of FIG. 8. However, to increase the wavelength tuning range, a plurality of matched tunable filters are including on separate rotable carousels such that the matched tunable filters may be brought into alignment to tune specific wavelengths within the wavelength range of the individual matched tunable filters.

A first set of filter assemblies 1502 are mounted on the periphery of a first carousel 1504. Each filter assembly includes an optical filter element 1530 coupled to a filter stage 1532 and a corner filter 1534 as in the tunable filters of FIG. 6, FIG. 7, and FIG. 8. In operation, the first carousel is rotated by a first actuator 1516 to bring a filter in a filter assembly into an optical path 1510 optical signal. The first carousel may be rotated to adjust the incidence angle of an optical signal relative to the filter. The corner mirror reflects any portion of the optical signal reflected by the filter back to the filter and back along the optical path as in the tunable filters of FIG. 6, FIG. 7, and FIG. 8.

A second set of optical filter assemblies 1504 are located on a peripheral portion of a second carousel 1506. The second carousel is operated by a second actuator 1520. The position of the second carousel is sensed by the second position sensor 1522.

In operation, a first optical assembly 1540 from the first set of optical assemblies is inserted into the optical path by rotating the first carousel. A corresponding second filter assembly 1542 from the second set of filter assemblies is rotated into the optical path by the second carousel. An input optical signal 1544 is transmitted by a first collimator 1508 along the optical path to the filter element of the first filter assembly, through a 90 degree polarization rotation element 1514, through the filter of the second filter assembly, and finally to a second collimator 1512. The input optical signal is thus processed in the same manner as the non-blocking tunable filter of FIG. 8.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. An angle tunable thin film interference optical filter, comprising:
a movable filter stage;
a thin film interference optical filter coupled to the movable filter stage;
a corner mirror coupled to the filter stage, the corner mirror receiving an optical signal reflected from the thin film interference optical filter; and
an actuator operable to move the filter stage such that the incidence angle of the optical signal relative to the thin film interference optical filter is modified.
